(19) United States
(12) Patent Application Publication
(10) Pub. No.: US 2004/0211745 A1
(43) Pub. Date: Oct. 28, 2004

(54) Nipple insert for a feeding bottle

(76) Inventor: Dale Murray, Elkton, MD (US)

Correspondence Address: Steven B. Pokotilow, Stroock & Stroock & Lavan LLP, 180 Maiden Lane, New York, NY, 10038, US

(21) Appl. No.: 10/749,097

(22) Filed: Dec. 30, 2003

Related U.S. Application Data
(60) Provisional application No. 60/437,233, filed on Dec. 31, 2002.

(51) Int. Cl. A61J 9/00

(52) U.S. Cl. 215/356; 215/387; 215/11.4

(57) ABSTRACT

A nipple insert for insertion into a sipper tube hole of a stopper of a cap assembly of a feed bottle containing a liquid. The nipple insert may include a body having a curved insertion portion, a nipple flange, disposed adjacent to the curved insertion portion, and a nipple extension, disposed adjacent to the nipple flange. The nipple extension may have a nipple extension face; and a feed hole defined, at least partially, in the nipple extension face. The nipple insert may further include a nipple recess inner wall, the nipple recess inner wall defining, in part, a nipple recess, the nipple recess having a depth dimensioned to facilitate cleaning of the recess. The nipple insert may be positioned in the sipper tube hole such that an animal may drink the liquid from the feed hole.

### CROSS-REFERENCE TO RELATED APPLICATION

This application claims the benefit of U.S. Provisional Patent Application Ser. No. 60/437,233, entitled “Nipple Insert for a Feeding Bottle,” which is hereby incorporated by reference herein.

### BACKGROUND OF THE INVENTION

1. Field of the Invention

The invention relates generally to feeding devices, and specifically to watering devices for animals.

2. Description of Related Art

Feeding bottles and other related feeding devices are well known in the art. Feeding bottles are frequently used for feeding animals, and more particularly, for feeding liquids to small animals that are retained in cages.

One type of feeding bottle typically used to feed small animals is bottles utilizing sipper tubes. The sipper tube allows for the animal to receive water contained in the water bottle. The tube is formed of stainless steel or another acceptable material, and typically allows a droplet of water to suspend from the end of the sipper tube for access by the animal. The remainder of the liquid is retained by the surface tension of the water droplet, even though the bottle is inverted. Typically, the stainless steel sipper tube is inserted into a tapered rubber stopper. The sipper tube is inserted into a hole formed in the middle of the rubber stopper, at the wider end of the tapered stopper. This sipper tube is forced into the hole in the stopper, thereby creating a liquid-tight seal between the sipper tube and the stopper by friction fit. This sipper tube and tapered stopper assembly is then forced into the opening of a bottle, thus creating a liquid-tight seal between the tapered stopper and the bottle; in effect plugging the bottle. In addition, variants of these sipper tubes, stoppers and bottles are also known, such as that described in U.S. Pat. No. 6,062,440 to Murray, et al., in which a flanged cap mechanism is used to facilitate a secure fit between a sipper tube stopper and a feeding bottle.

Several deficiencies exist, however, with the use of a sipper tube. Washing and sanitizing of the sipper tubes is often difficult, because the structure of the sipper tubes is relatively long and narrow. Additionally, the sipper tubes often include angled bends that further complicate the cleaning process.

To maintain sanitary drinking conditions for the animals, the bottles, rubber stoppers, caps, and sipper tubes must be frequently washed and/or autoclaved. Due to the above-mentioned shape and structure of the sipper tubes, for practical reasons, to achieve thorough cleaning, the sipper tubes must be removed from the stopper and plug assembly prior to cleaning and/or autoclaving. The extra time burden caused by this extra step is multiplied in view of the fact that many facilities house large numbers of animals and cages, with corresponding large numbers of feeder bottles, and thus the additional step of removing a sipper tube prior to cleaning is multiplied by the large number of feeder bottles.

Another deficiency with the use of sipper tubes is that flooding of an animal's cage is likely. Because the sipper tube is designed such that it extends down, from the bottle, into the cage, it is common for animals to unintentionally brush up against the bottom of the sipper tube or bedding material may be easily pushed against the sipper tube, causing water to leak onto, and be absorbed by, the bedding material at the bottom of the cage. This excess of water within the cage has two immediate problems: 1) liquid from the bottle is not being consumed by the animal; and 2) excess liquid in the cage can facilitate the animal becoming ill from, for example, hypothermia, and the ammonia and humidity buildup in the cage may be accelerated.

Another type of feeding bottle often used is the so-called “drilled-hole” bottle. The drilled-hole bottle is typically made of plastic and includes a hole drilled in its side. After water or some other suitable liquid is placed into the drilled-hole bottle, the drilled-hole bottle is typically sealed with a cap and solid plug (the plug having no hole for a sipper tube). The drilled-hole bottle is then situated near the top of an animal cage. Water collects generally as a droplet at the hole, and the animals drink the liquid by licking it from the hole. Use of the drilled-hole bottle has several advantages. One such advantage is that a sipper tube, with its requisite cleaning requirements, are not used with the drilled-hole bottle.

Referring first to FIG. 1, there is shown generally a related drilled-hole bottle and cage lid assembly. The assembly includes a cage lid and a drilled-hole bottle. The lid is typically formed of a sturdy material, such as steel, and is typically mounted at the top of an animal cage (not shown) as is known in the art. The lid typically includes bottle retention portion, for retaining the drilled-hole bottle, oriented along a substantially horizontal axis.

The drilled-hole bottle typically has a body formed of plastic. A cap is used in conjunction with a solid stopper are used to seal drilled-hole bottle. Typically, during manufacturing of the drilled-hole bottle, a hole is drilled or otherwise created in the side of the body of the drilled-hole bottle.

In use, drilled-hole bottle is filled with a liquid, such as water, and sealed by way of cap and solid stopper (because the drilled-hole bottle is not used with a sipper tube, a solid stopper, without a sipper tube hole, is used). The drilled-hole bottle is then positioned in the retention portion of the cage lid, oriented along a substantially horizontal axis.

An animal (not shown) may then drink from the water, or other liquid, droplets that form at hole. Due to the substantially horizontal orientation of the drilled-hole bottle, unused liquid typically remains in the drilled-hole bottle after the animal has consumed all of the liquid that it is able to consume. The unused liquid remains in a portion of the drilled-hole bottle, located below the level of the hole, because the effect of gravity will not force liquid located at a lower level than the hole to drip out.

Several deficiencies exist, however, with the use of a drilled-hole bottle. First, because the drilled-hole is located at the side of the bottle, the bottle is typically positioned and oriented sideways, or horizontally, so that an animal within the cage may easily access the liquid, and so that the liquid may suitably drip out of the bottle. Due to the horizontal orientation of the drilled-hole bottle, and the typical shape and contours of a drilled-hole bottle, however, a relatively large portion of the liquid in the bottle cannot be used by the animal, and remains in the bottle at a point after which no more liquid will drip from the bottle. The use of less than all of the liquid in the bottle results in the more frequent need for refilling the bottles. Again, if a facility houses a large number of animals, with a corresponding large number of feeding bottles, then the additional work required to more frequently refill the drilled-hole bottles is multiplied by the large number of bottles to be refilled.

Another deficiency with the use of drilled-hole bottles is that the hole is typically drilled to a pre-determined diameter at the manufacturer's site and is delivered to the user as such. For various reasons, such as, for example, the need for bottles with different drip rates, a user may desire bottles with different hole diameters. Because the drilled-hole bottles arrive at the user's site with holes having a predetermined diameter, if a different hole diameter is required, the user must order another bottle, while specifying a different hole diameter. This requirement may necessitate the need for storage of various bottles with different hole diameters.

As such, a need exists for an improved system and method for feeding liquids to animals.

### SUMMARY OF THE INVENTION

The present invention satisfies these and other needs. Various embodiments of the present invention provide for a nipple insert that may be used with a bottle and cap assembly.

According to an exemplary embodiment of the present invention, a nipple insert for insertion into a sipper tube hole of a stopper for a feed bottle, generally comprises a body having a curved insertion portion, a nipple flange, disposed adjacent to the curved insertion portion, and a nipple extension, disposed adjacent to the nipple flange. The nipple extension may have a nipple extension face, and a feed hole defined, at least partially, in the nipple extension face. The nipple insert may be positioned in the sipper tube hole such that an animal may drink a liquid from the feed hole.

Generally, the sipper tube hole has a first diameter, and the curved insertion portion has a second diameter, with the second diameter being greater than said first diameter. Consequently, the sipper tube hole may be distorted upon insertion of the curved insertion portion, grippingly retaining the insertion portion. Likewise, the nipple insert flange has a third diameter which is greater than said first and second diameters.

Furthermore, an exemplary embodiment of the invention may comprise a cap having a curved side wall having an inner surface and an outer surface, a circumferential flange extending from the curved side wall and defining an opening in the cap, and a stopper dimensioned to seal the opening. The stopper may have a hole therein, and be maintained in the cap by the circumferential flange. An exemplary embodiment of the invention may further comprise a nipple insert dimensioned to be positioned within the hole and extending through the opening. The nipple insert may include a body having a curved insertion portion, a nipple flange, disposed adjacent to the curved insertion portion, and a nipple extension, disposed adjacent to the nipple flange. The nipple extension may have a nipple extension face, and a feed hole defined, at least partially, in the nipple extension face. The nipple insert may be positioned in the sipper tube hole such that an animal may drink the liquid from the feed hole.

Other objects and features of the present invention will become apparent from the following detailed description, considered in conjunction with the accompanying system schematics and flow diagrams. It is understood, however, that the drawings, are solely for the purpose of illustration and not as a definition of the limits of the invention, for which reference should be made to the appended claims.

### BRIEF DESCRIPTION OF THE DRAWING FIGURES

In the drawing figures, which are merely illustrative, and wherein like reference numerals depict like elements throughout the several views:

FIG. 1 is a side view of a prior art drilled-hole water bottle mounted in a cage lid assembly;

FIG. 2 is a perspective view of a nipple insert in accordance with an exemplary embodiment of the present invention;

FIG. 3 is a side cross-sectional view of the nipple insert of FIG. 3;

FIG. 4 is a bottom view of the nipple insert of FIG. 3;

FIG. 5 is a perspective view illustrating the relative placement of a cap, stopper, nipple insert and bottle an embodiment of the present invention; and

FIGS. 6-7 are perspective views illustrating the relative placement of a cap, stopper and nipple insert in an embodiment of the present invention.

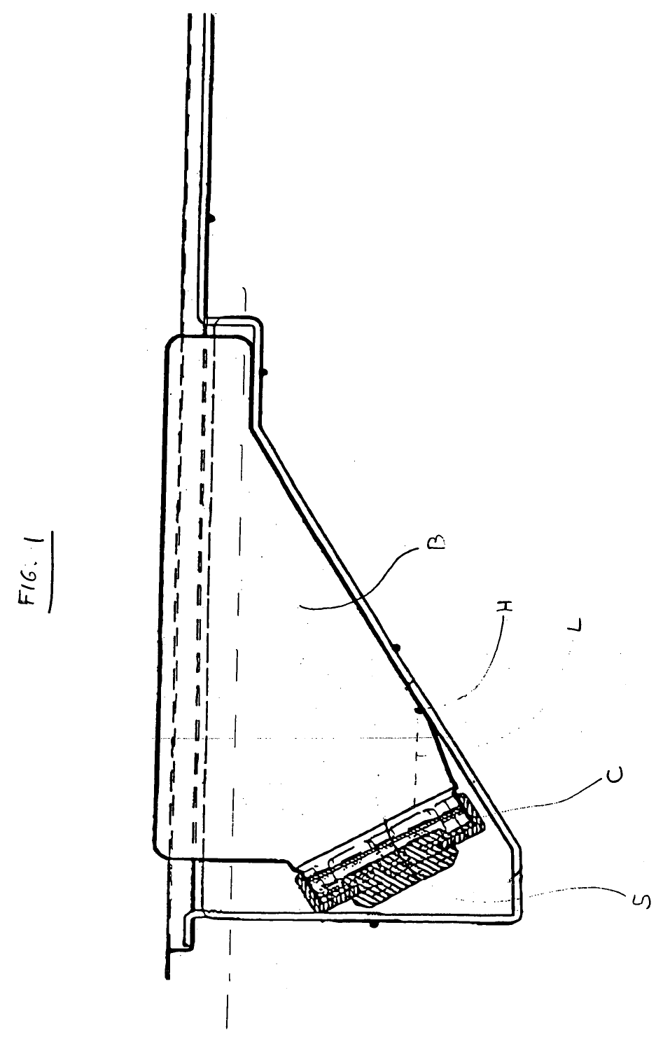

### DETAILED DESCRIPTION OF EXEMPLARY EMBODIMENTS

There will now be shown and described in connection with the attached drawing figures several exemplary embodiments of a nipple insert for insertion into a sipper tube hole of a stopper of a cap assembly of a feed bottle containing a liquid.

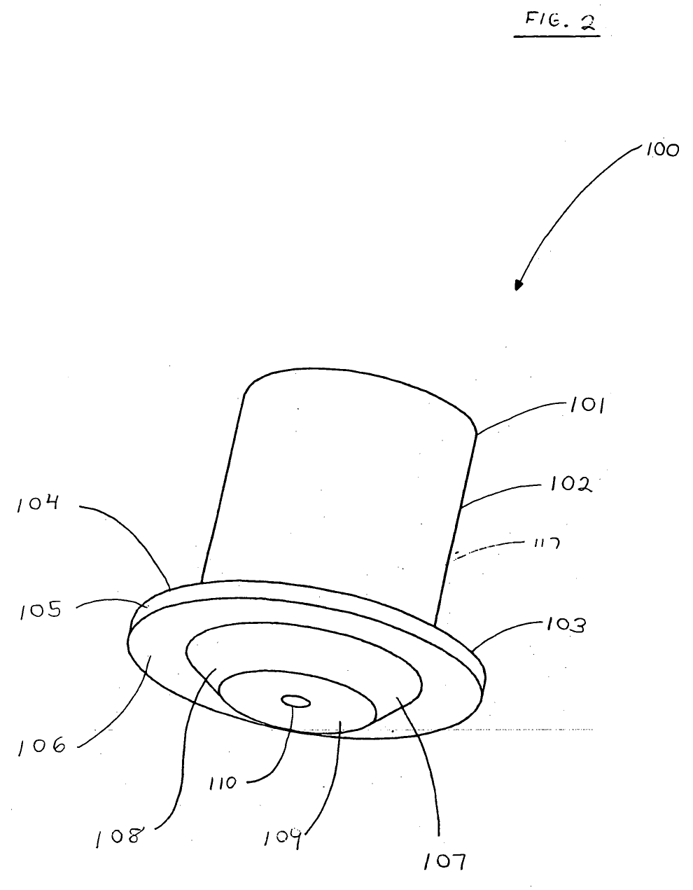

Referring next to FIG. 2, there is generally illustrated a nipple insert 100 in accordance with an embodiment of the present invention. Nipple insert 100 may have body 101 including an insertion portion 117, a flange 104 and an extension portion 107.

In an embodiment of the invention, nipple insert 100 may be formed of a single integral piece of material, although in an embodiment of the invention, nipple insert 100 may be formed of more than one piece. In an embodiment of the invention, nipple insert may be formed of stainless steel, or other such material that may facilitate cleaning and/or autoclaving to achieve sanitary conditions suitable for dispensing liquids to animals as is known by those skilled in the art.

In an embodiment of the invention, insertion portion 117 of nipple insert 100 may have a curved outer face 102. Curved outer face 102 may be relatively smooth, and substantially cylindrical in shape, although other textures and/or shapes may be used as a matter of design choice.

In an embodiment of the invention, flange 104 may have a rear face 103, a front face 106 and an edge 105.

In an embodiment of the invention, extension portion 107 may have angled wall 108 and extension face 109: Feed hole 110 may be defined in extension face 109. Thus, extension portion 107 may provide separation between feed hole 10 and face 109, and front face 106. Such separation may facilitate minimization of leakage due to inadvertent contact between the feed hole 10 and the side of an assembly (not shown) in which the bottle 50 may be mounted. Such separation may also facilitate the positioning of the nipple insert 100 of an assembly (not shown) in which the bottle 50 may be mounted.

In an embodiment of the invention, however, nipple insert 100 need not have extension portion 107. In such an embodiment, feed hole 110 may be defined in front face 106 of flange 104 (with extension face 109 and front face 106 essentially being the same face). Additionally, in an embodiment of the invention, angled wall 108 need not be angled, but may be oriented, by way of a non-limiting example, perpendicular to front face 106.

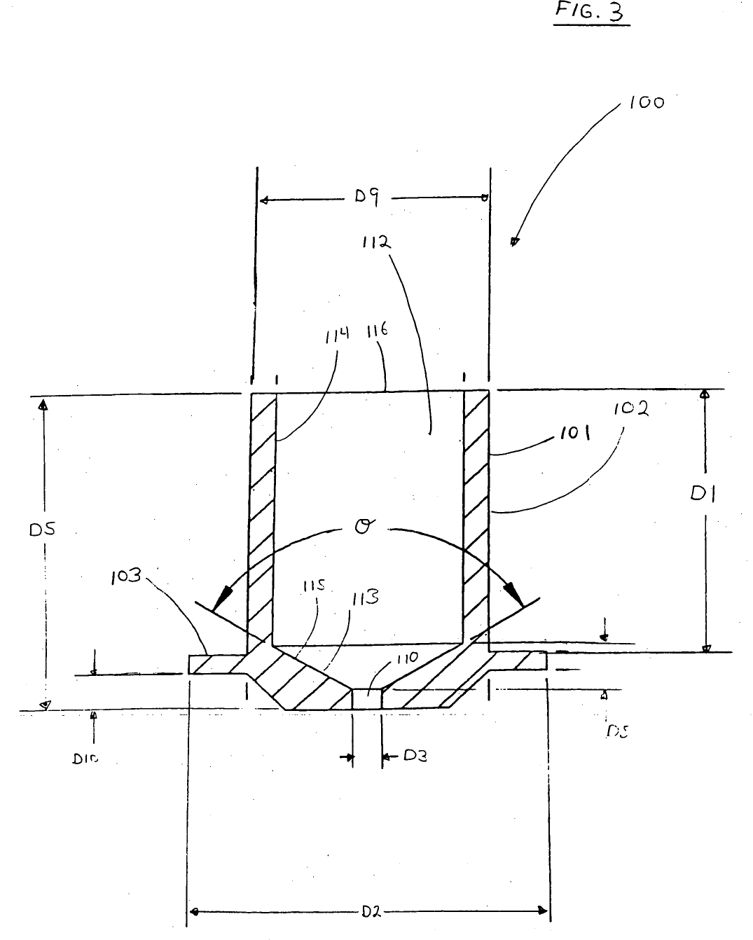

Referring to FIGS. 2-4, and particularly to FIG. 3, insertion portion 117 of nipple insert 100 may have inner face 114, which may define, at least in part, aperture 112 having entrance 116. Nipple insert 100 may also have recess wall 115, which may define, at least in part, recess 113. Recess 113 is adjacent to both aperture 112 and feed hole 110.

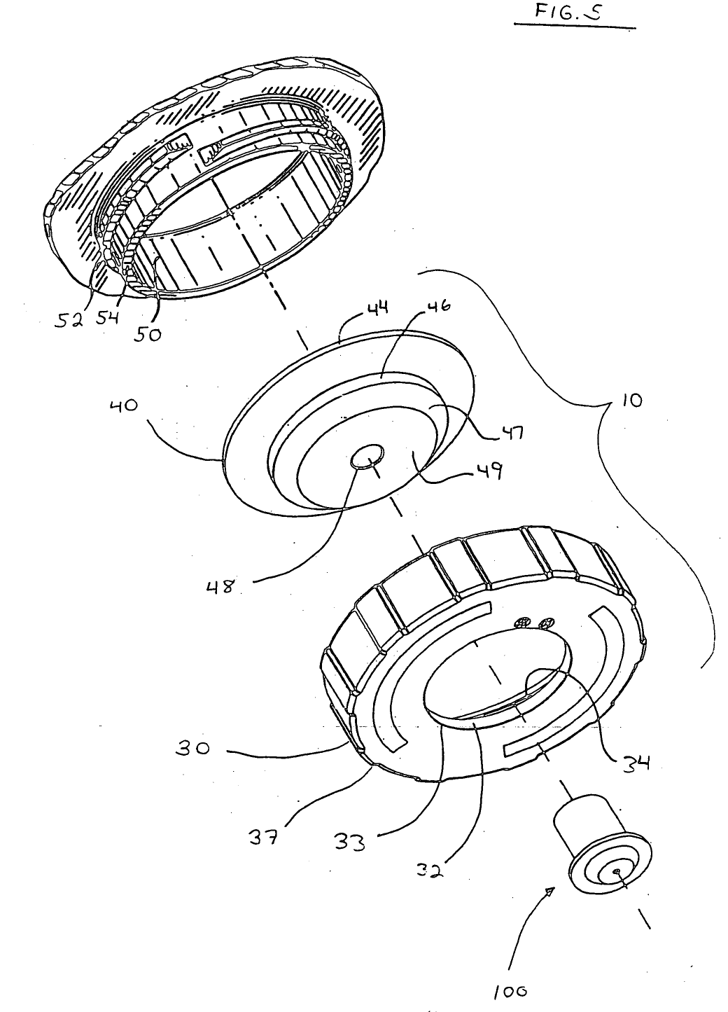

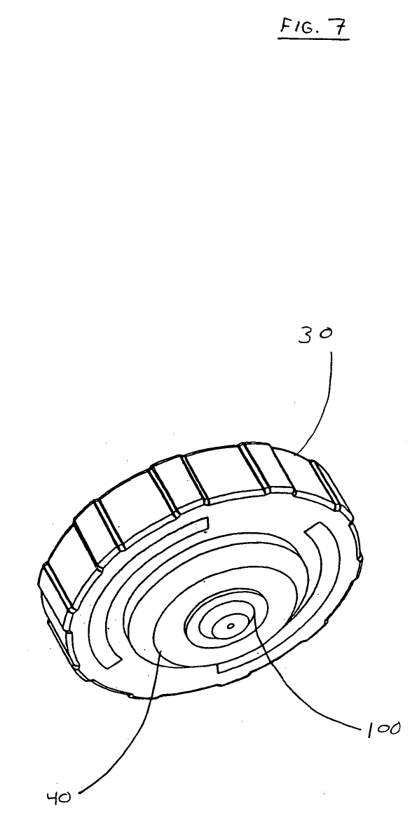

With reference to FIGS. 2, 3, 5, 6 and 7, a flat surface forming a circumferential flange 32 extends inward from the outer edge of side wall 37 across the top of cap 30. Circumferential flange 32 defines an opening 33 formed in cap 30. Opening 33 is formed with a diameter D, which is greater than the diameter of vertical portion 22 of sipper tube 20. Wall 37 is further formed with threads 34 on the inside surface thereof. Additionally, serrations 36 are formed on the outer surface of curved wall 37 of cap 30, facilitating gripping of cap 30 by a user. Cap 30, and threads 34 are dimensioned so as to mesh with threads of the neck of a standard bottle 50; threads 34 engaging standard threads 52 thereon. Bottle 50 may be a standard bottle which is known in the industry.

Stopper 40 is formed with a first lip 44 and a second lip 46. Both lip 44 and lip 46 have a diameter substantially greater than opening 33. A neck 42 having a diameter less than first lip 44 and second lip 46 is disposed therebetween and has a diameter no smaller than D. Second lip 46 is formed with a slanted upper surface 47 and a top face 49. A hole 48 is formed through stopper 40. Stopper 40 is formed of a resilient material, such as rubber, silicone rubber, or any other FDA approved, non-hazardous material or the like. Hole 48 is dimensioned to be slightly smaller than the diameter of vertical portion 22 of sipper tube 20 so that sipper tube 20 may be force-fit within hole 48 stretching stopper 40 around sipper tube 20 and forming a liquid-tight seal therebetween.

During use, stopper 40 is fit into opening 33 of cap 30. Because lip 46 has an angled top surface 47 and is formed of a malleable material, lip 46 slides through opening 33 as flange 32 compresses lip 46 and surface 47 slides through opening 33. The larger diameter lip 44 which has no such surface cannot pass through opening 33.

In use, nipple insert 100 and cap assembly 10, including cap 30 and stopper 40, may be positioned such that stopper 40 is positioned adjacent cap 30, as described above. Additionally, nipple insert 100 may be positioned partially within hole 48 of stopper 40. In turn, the cap 30, stopper 40 and nipple insert 100 may be secured to a bottle 50.

In use, nipple insert 100 may be inserted into hole 40 of stopper 40. Additionally, while nipple insert 100 is described herein as being used in conjunction with cap 30, stopper 40 and bottle 50, nipple insert 100 may also be used with other types of stoppers, caps and bottles as are known by those skilled in the art.

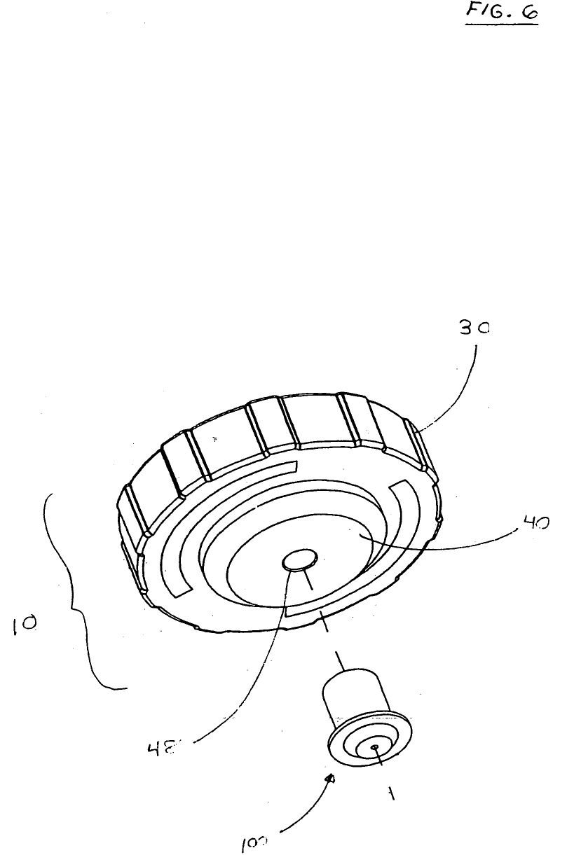

Referring again to FIG. 3, in an embodiment of the invention, insertion portion 117 has a diameter D9 dimensioned such that it is slightly larger than the diameter of hole 48 in stopper 40. D9 preferably may be in the range of 0.312 to 0.390 in., and more preferably about 0.375 in. Accordingly, insertion portion 117 may be force-fit into hole 48 of stopper 40 (see FIGS. 6-8). In an embodiment of the invention, flange 104 has a diameter D2 dimensioned such that it is substantially greater than the diameter of hole 48. Accordingly, insertion portion 117 may be force-fit into hole 48 until rear face 103 of flange 104 abuts the top face 49 of stopper 40. D2 preferably may be in the range of 0.500 to 0.625 in., and more preferably about 0.563 in.

In an embodiment of the invention, insertion portion 117 may have a length D1 dimensioned such that insertion portion 117 is no longer than necessary to satisfactorily secure nipple insert 100 at hole 48 of stopper 40. D1 preferably may be in the range of 0.219 to 0.657 in., and more preferably about 0.438 in.

As a user is force-fitting the nipple insert 100 into stopper 40, the user may beneficially receive tactile feedback that the nipple insert 100 is fully inserted as he or she feels the rear face 103 of flange 104 abut against the top face 49 of stopper 40.

As an additional benefit, flange 104 facilitates the protection of stopper 40 from damage by animals as they drink. As the animal drinks liquid from feed hole 110, flange 104, by extending outwardly, blocks, at least partially, the animals from contacting portions of top face 49 of stopper 40.

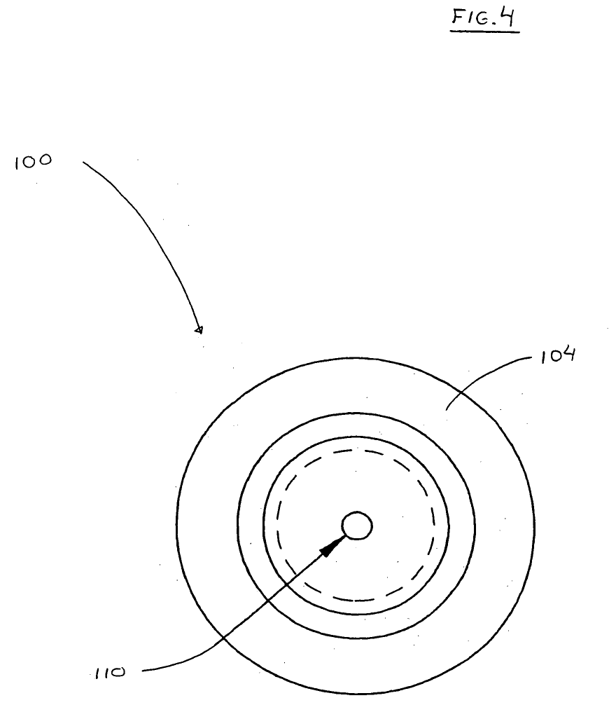

In use, a liquid, such as water is placed in the bottle 50, and the cap 0.30, stopper 40 and nipple insert 100 are secured on bottle 50, as described above. The bottle 50 is then positioned in a vertical orientation, with nipple insert 100 at the bottom. Referring again to FIG. 4, in an embodiment of the invention, feed hole 110 has a diameter D3 dimensioned such that a droplet of liquid will be positioned at feed hole 110, allowing an animal to consume liquid from bottle 50. D3 preferably may be in the range of 0.031 to 0.076 in., and more preferably about 0.046 in. In an embodiment of the invention, a variety of nipple inserts, having a variety of diameters D3 may be provided, such that, in the event that a feed hole 110 of a different diameter is desired, the user only need remove one nipple insert, and replace it with another having a feed hole 110 with a different diameter D3. Accordingly, if a different feed hole size is required to, for example, provide for a different feed rate, the user may use the same bottle, cap and stopper, and need only change the nipple insert 100.

In use, the liquid passes from the bottle 50, into the entrance 116 to aperture 112, on to recess 113, and out through feed hole 110. In an embodiment of the invention, recess 113 has a depth D8 dimensioned such that it is relatively shallow, to facilitate cleaning of recess 113. D8 preferably may be in the range of 0.060 to 0.090 in., and more preferably about 0.075 in. Additionally, recess wall 115 may be angled such that the angle 0 from one portion of recess wall 115 to the opposite portion is also dimensioned to facilitate cleaning of recess portion 113. θ preferably may be in the range of 100 to 135°, and more preferably about 118.0°.

Referring again to FIG. 3, in an embodiment of the invention, nipple insert 100 has a length D5 dimensioned such that the ratio of length D5 to diameter D9 is in the range of 1:3:1 to 1.5:1. This ratio facilitates stable positioning of nipple insert 100 within hole 40, proper flow of liquid through aperture 112, and proper cleaning of nipple insert 100. D5 preferably may be in the range of 0.312 to 0.750 in., and more preferably about 0.531 in.

Another benefit of the present invention is that the combination of relatively short length D5 and shallow recess depth D8 allow a user to leave nipple insert 100 in stopper 40 during cleaning and/or autoclaving processes. Accordingly, no time or effort is wasted for removing the nipple insert for cleaning.

Furthermore, since, during use, bottle 50 may be positioned in a substantially vertical orientation, such that feed hole 110 is located at a point lower than all of the liquid, substantially all of the liquid contained in bottle 50 may be consumed by an animal.

Still further, because of the relatively short distance D10 that extension portion 107 extends out from flange 104, it is less likely that an animal will brush against the nipple insert (as is typical when sipper tubes are used) and flood the cage with liquid. In an embodiment of the invention, extension portion 107 extends outward from flange 104 for a distance D10 to facilitate easier access by an animal. D10 preferably may be in the range of 0.048 to 0.125 in., and more preferably about 0.062 in.

While the invention has been described in connection with preferred embodiments, it will be understood that modifications thereof within the principles outlined above will be evident to those skilled in the art and thus, the invention is not limited to the preferred embodiments but is intended to encompass such modifications.

What is claimed:

1. A nipple insert for insertion into a sipper tube hole of a stopper of a cap assembly of a feed bottle containing a liquid, said nipple insert comprising:
a body having a curved insertion portion, a nipple flange, disposed adjacent to said curved insertion portion, and a nipple extension, disposed adjacent to said nipple flange;
said nipple extension having a nipple extension face; and
a feed hole defined, at least partially, in said nipple extension face;
wherein said nipple insert may be positioned in the sipper tube hole such that an animal may drink the liquid from said feed hole.

2. The nipple insert of claim 1, wherein the sipper tube hole has a first diameter, and said curved insertion portion has a second diameter, said second diameter being greater than said first diameter.

3. The nipple insert of claim 2, wherein said nipple flange has a third diameter, said third diameter being greater than said first and second diameters.

4. The nipple insert of claim 1, said nipple flange having a rear face dimensioned to abut the stopper of the cap assembly such that said nipple flange facilitates protection of a portion of the stopper proximate the sipper tube hole when an animal drinks from said nipple insert.

5. The nipple insert of claim 1, said nipple insert further comprising a nipple recess inner wall, said nipple recess inner wall defining, in part, a nipple recess, said nipple recess having a depth dimensioned to facilitate cleaning of said recess.

6. The nipple insert of claim 5, the nipple recess inner wall further defining an angle, said angle being dimensioned to facilitate cleaning of said recess.

7. The nipple insert of claim 1, wherein said nipple insert is formed of a single integral piece of material.

8. The nipple insert of claim 7, wherein said material is stainless steel.

9. The nipple insert of claim 1, wherein an animal may drink liquid from the feed hole when the bottle is disposed in a substantially vertical direction.

10. The nipple insert of claim 1, wherein the animal may drink substantially all of the liquid in the bottle from the feed hole.

11. The nipple insert of claim 1, wherein the bottle has water level indicators and the water level indicators may be read while the bottle, the stopper, the cap and said nipple insert are positioned to facilitate drinking by the animal.

12 The nipple insert of claim 1, said nipple insert having a length and a width, a ratio of said length to said width being in the range of 1.3:1 to 1.5:1.

13. A nipple insert comprising:
a body having a curved insertion portion, a nipple flange, disposed adjacent to said curved insertion portion, and a nipple extension, disposed adjacent to said nipple flange;
said nipple extension having a nipple extension face; and
a feed hole defined, at least partially, in said nipple extension face.

14. A feed bottle cap assembly comprising:
a cap having a curved side wall having an inner surface and an outer surface;
a circumferential flange extending from said curved side wall and defining an opening in said cap;
a stopper dimensioned to seal said opening, said stopper having a hole therein, said stopper being maintained in said cap by said circumferential flange; and
a nipple insert dimensioned to be positioned within said hole and extending through said opening, said nipple insert including;
a body having a curved insertion portion, a nipple flange, disposed adjacent to said curved insertion portion, and a nipple extension, disposed adjacent to said nipple flange;
said nipple extension having a nipple extension face; and
a feed hole defined, at least partially, in said nipple extension face;
wherein said nipple insert may be positioned in the sipper tube hole such that an animal may drink the liquid from said feed hole.

15. A method of forming a nipple insert for insertion into a sipper tube hole of a stopper of a cap assembly of a feed bottle containing a liquid, said method comprising:
forming a body having a curved insertion portion, a nipple flange, disposed adjacent to said curved insertion portion, and a nipple extension, disposed adjacent to said nipple flange;
said nipple extension having a nipple extension face; and
a feed hole defined, at least partially, in said nipple extension face;
wherein said nipple insert may be positioned in the sipper tube hole such that an animal may drink the liquid from said feed hole.

16. A method of assembling a feed bottle assembly comprising:
providing a cap having a curved side wall having an inner surface and an outer surface;
providing a circumferential flange extending from said curved side wall and defining an opening in said cap;
providing a stopper dimensioned to seal said opening, said stopper having a hole therein, said stopper being maintained in said cap by said circumferential flange; and
providing a nipple insert dimensioned to be positioned within said hole and extending through said opening, said nipple insert including;
providing a body having a curved insertion portion, a nipple flange, disposed adjacent to said curved insertion portion, and a nipple extension, disposed adjacent to said nipple flange;
said nipple extension having a nipple extension face; and
providing a feed hole defined, at least partially, in said nipple extension face;
wherein said nipple insert may be positioned in the sipper tube hole such that an animal may drink the liquid from said feed hole.
